(19) United States
(12) Patent Application Publication
(10) Pub. No.: US 2004/0261531 A1
(43) Pub. Date: Dec. 30, 2004

(54) Method and system for analyzing hydraulic turbine vibrations

(75) Inventors: Andre Coutu, Boucherville (CA); Stuart Thomas Coulson, Beaconsfield (CA); Daniel Proulx, Longueuil (CA)

Correspondence Address: CRAIG WILSON, 2570 MATHESON BLVD. EAST, SUITE 211, MISSISSAUGA, ON, L4W 4Z3, CA

(73) Assignee: General Electric Canada Inc., Mississauga (CA)

(21) Appl. No.: 10/608,214

(22) Filed: Jun. 30, 2003

(51) Int. Cl. G01N 29/14

(52) U.S. Cl. 73/587; 702/56

(57) ABSTRACT

A method and system for analyzing hydraulic turbine noise vibrations involves recording the noise of a hydraulic turbine either during operation or intentionally produced for testing from a remote site. A standard laptop computer is utilized by personnel at the turbine site to record the sound at different power outputs as specified by turbine experts with a standard Windows sound recording program that produce sound files. The sound files are compressed at the site and sent to the expert office location via Email. Once received at the expert location, the sound files are uncompressed and analyzed immediately by the turbine experts without the experts having had to travel to the remote site. The analysis is done with a software sound analyzer. The analyzed signals are used to diagnose the machine and address any unusual recorded noise.

### FIELD OF THE INVENTION

The present invention relates to a method and system for recording the noise of a hydraulic turbine either during operation or intentionally produced from a remote site and for sending the recorded noise information to an office where the experts are able to analyze the noise information.

### BACKGROUND OF THE INVENTION

Until recently, hydraulic turbines have been used to be operated close to peak efficiency. At this optimum operating point, dynamic forces on the turbine components are generally low, with the exception of transient conditions such as load rejection and surge.

Due to new market conditions, mainly driven by deregulation, the operating conditions of hydroelectric power plants have switched from maximization of energy to maximization of profits. This typically involves operating the turbine through spinning reserve for peak demand operation. The turbine is operated to make frequent start/stops and operated at off-peak conditions resulting in higher solicitation of the turbine components and in particular the turbine runner. At the extreme, the turbine is operated over full range, from speed-no-load to 100% and above on a regular basis. The turbines have not been initially designed to operate under such conditions. Typical turbine operation specifications call for turbine operation not too far from peak where the turbine runs usually smoothly with very little hydraulic instabilities. When the turbine operates away from this peak efficiency operating point however, many dynamic phenomena may occur such as, for example, pressure fluctuations from the draft tube, mechanical and hydraulic unbalances, interaction with the wicket gates, interblade vortices, Von Karman vortices and unstable zones that occur mostly at partial load.

The hydraulic behaviour of the turbine is the source of most of these phenomena. There are no tools readily available today that can be used for the accurate prediction of all these instabilities.

This dynamic phenomena is known to create audible vibrations which may be referred to as a hydraulic turbine “singing”. Sound recordings of the turbine singing have been made in the past with dedicated equipment that required well-trained and highly specialized experts taking and analyzing the recordings at the turbine site. Sending these experts to remote sites is quite expensive, and usually requires some advance notice. Further, these experts need to bring expensive hardware and software to the remote sites to extract any information of value from the output data of the sound meters used to record the phenomena. The report format generally comprises a table filled up with numbers from which it is not obvious to extract useful information.

There is a need for a relatively easy method and system for obtaining and analyzing the audible singing tones of a hydraulic turbine without the notice delay and expense of sending experts with expensive computer tools to remotes sites.

### SUMMARY OF THE INVENTION

The present invention relates to a method and system for recording the noise of a hydraulic turbine either during operation or intentionally produced from a remote site and for sending the recording noise information to an office where the experts are able to analyze the noise information. The analysis of the noise may then result in a diagnosis that may then be applied to find solutions to the noise by suggesting alterations in the turbine design.

The method and system of the present invention involves receiving at an expert site sound recording files of a singing turbine recorded at a remote site which recordings are then analyzed at the expert site.

In one embodiment, the recording of sound files is implemented by using a standard laptop computer. Personnel at the site are sent to the turbine pit to record the sound at different power outputs as specified by the experts at a remote site. Windows sound recorder software may be used with a portable computer and microphone to create sound files. The sound files are compressed and sent to the expert site via a communication link which may be any suitable telecommunication link and is an email internet link in one embodiment. Once received, the sound files are uncompressed and analyzed by the turbine experts without requiring that the experts travel to the remote site. The analysis is done with a software sound analyzer. The analyzed signals are used to diagnose the machine and address any unusual recorded noise.

The advantage of the method is that it is low cost, less time consuming in the collection of information and requires a low level of expertise needed at site.

### BRIEF DESCRIPTION OF THE DRAWINGS

For a better understanding of the nature and objects of the present invention reference may be had to the accompanying diagrammatic drawings in which:

FIG. 1 is a perspective view showing the testing at a remote site and the forwarding of information to an expert site;

FIG. 2 is a view of the sound recorder program utilized by the method of the present invention; and

FIG. 3 is a flowchart showing the steps in the method of the present invention.

### DETAILED DESCRIPTION OF THE INVENTION

The present invention relates to a method and system for recording the noise of a hydraulic turbine either during operation or intentionally produced from a remote site and for sending the recorded noise information to an office where the experts are able to analyze the noise information.

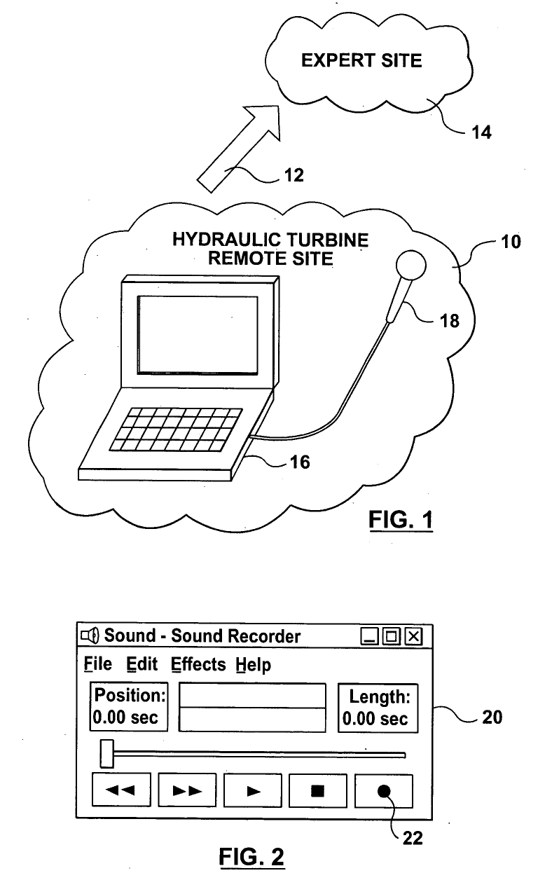

Referring to FIGS. 1 through 3, the method and system of the present invention are now described.

The purpose of the present invention is to provide a simple and effective means for interrogating sound noise vibrations produced at a remote site 10 of a hydro electric facility. Once the sound noise vibration is recorded, this information is forwarded via internet e-mail, as indicated by arrow 12 in FIG. 1, to an expert site 14. It should be understood that the remote site 10 housing the turbine may be in one geographical location and the expert site 14 may be in another geographical location.

It is contemplated in the present invention that a remote site recorder comprising a portable computer 16 is utilized with a microphone 18 placed close to various positions in the turbine pit to record sound information. The sound information is recorded by using a simple Windows sound recorder program provided with the operating system of the portable computer 16. The Windows program is exemplified at designation number 20 shown in FIG. 2. This program is operated by simply pressing the record button 22 and recording any noise produced or received from the microphone 18 and saving it as a Windows sound file.

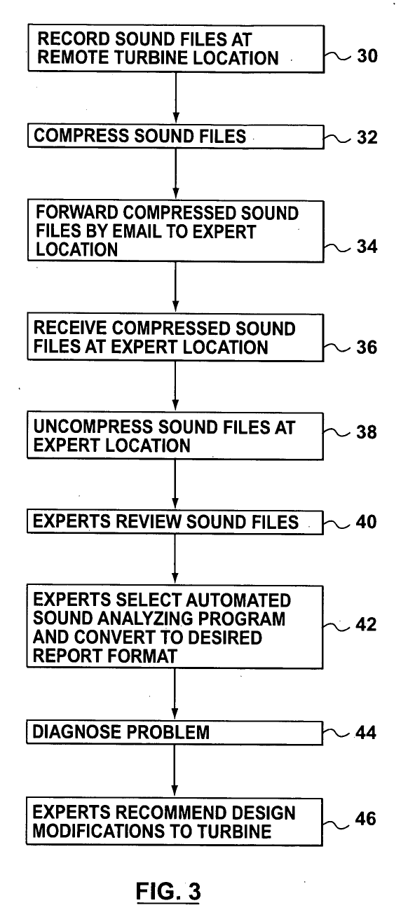

Referring to FIG. 3, the sound recording at the remote turbine location 10 is exemplified by step 30 in the method flowchart shown. Next, the sound files captured by the portable computer 16 in step 30 are compressed to at step 32. The compressed files 32 are forwarded via internet email to the expert location 14 as indicated by step 34 in the flowchart of FIG. 3.

Subsequently, at step 36, the sound files, are received at the expert location 14 as indicated. The sound files are then uncompressed at the expert location as per step 38.

The uncompressed sound files are reviewed by the experts at site 14 and this review may include listening to the files. Next, at step 42, the experts select an automated sound analyzing program that converts the sound information into a report format that is analyzed by the experts. The experts then at step 44 diagnose the problem that is producing this abnormal sound information in the turbine and, at step 46, the experts recommend turbine design modifications to eliminate the disturbances.

It should be understood that in the initial recording of the sound files at step 30, experts are not required to preform this operation at the remote site 10. This operation may be preformed by technical people who have been instructed by the experts to preform specific sound tests. These tests may involve either a placement of the microphone and the recording of sound information while running the turbine at different operating conditions, or alternatively may be provided by producing sound by tapping or hitting the turbine on its outside walls at various positions within the turbine pit. These files are identified in accordance with the testing or recording information and forwarded to the expert location 14.

At the expert location or site 14, the experts will select automated sound analyzing programs to analyze the sound information and output it in a report format that may be scrutinized by the experts.

While the invention has been described in connection with what is presently considered to be a practical embodiment, it is to be understood that the invention is not to be limited thereto, but on the contrary, is intended to cover various modifications and equivalent arrangements included within the spirit and scope of the appended claims.

What is claimed is:

1. A method for analyzing turbine noise vibrations comprising the steps of:
receiving at an expert site recorded noise information relating to noise of a hydraulic turbine recorded at a remote site either during turbine operation at the remote site or intentionally produced for test purposes at the remote site; and,
analyzing the recorded noise information at the expert site.

2. The method of claim 1 further included the step of diagnosing the cause of the turbine noise information and modifying turbine design.

3. The method of claim 1 wherein the step of receiving the computer noise information involves receiving a computer file from the remote site via email.

4. The method for analyzing turbine noise vibrations comprising the steps of:
recording noise of a hydraulic turbine either during turbine operation at a remote site or intentionally produced for test purposes from the remote site to produce recorded noise information;
forwarding the recorded noise information from the remote site via a communication link to an expert site; and,
analyzing the recorded noise information at the expert site.

5. The method of claim 4 further including the step of diagnosing the cause of the turbine noise information and modifying turbine design.

6. The method of claim 5 wherein the step of recording utilizes a portable computer and microphone connected to the computer for recording the noise information into the computer file.

7. The method of claim 6 wherein a Windows sound recorder program is utilized to capture the noise information.

8. The method of claim 6 further comprising the steps of:
compressing the computer file of the recorded noise prior to the step of forwarding the recorded noise information to the expert site; and,
un-compressing computer file of the recorded noise at the expert site prior to the step of analyzing the recorded noise information.

9. The method of claim 4 wherein the step of forwarding the computer noise information involves sending the file from the remote site to the expert site via email.

10. The method of claim 9 wherein the step of recording utilizes a portable computer and microphone attached to the computer for recording the noise information into the computer file.

11. The method of claim 7 wherein a Window sound recorder program is utilized to capture the noise information.

12. The method of claim 10 further comprising the steps of:
compressing the computer file of the recorded noise prior to the step of forwarding the recorded noise information to the expert site; and,
un-compressing the computer file of the recorded noise at the expert site prior to the step of analyzing the recorded noise information.

13. A system for analyzing turbine noise vibrations comprising:
an expert site for receiving from a communication link recorded noise information relating to noise of a hydraulic turbine recorded at a remote site either during turbine operation at the remote site or intentionally produced for test purposes at the remote site; and,
analyzing tool for analyzing the recorded noise information at the expert office site.

14. The system of claim 13 wherein the expert site further diagnoses the cause of the turbine noise information and recommends modifications to turbine design.

15. The system of claim 13 wherein the step of receiving the computer noise information involves receiving a computer file from the remote site via email.

16. A system for analyzing turbine noise vibrations comprising:
a remote site recorder for recording the noise of a hydraulic turbine either during turbine operation at a remote site or intentionally produced for test purposes from the remote site to produce recorded noise information;
a communication link for forwarding the recorded noise information from the remote site to an expert site; and,
an analyzing tool for analyzing the recorded noise information at the expert site.

17. The system of claim 16 further including diagnosing the cause of the turbine noise information and modifying turbine design.

18. The system of claim 17 wherein the remote site recorder comprises a portable computer and microphone attached to the computer for recording the noise information into the computer file.

19. The system of claim 18 wherein the remote site recorder comprises a sound recording program utilized to capture the noise information.

20. The system of claim 18 where the remote site compresses the computer file of the recorded noise and the expert site un-compressing the computer file of the recorded noise.

21. The system of claim 13 wherein the communication link forwarding the computer noise information involves sending the file from the remote site to the expert site via email.

22. The method of claim 21 wherein the remote site recorder comprises a portable computer and microphone attached to the computer for recording the noise information into the computer file.

23. The method of claim 17 wherein the remote site recorder comprises a program utilized to capture the noise information.

24. The method of claim 22 wherein the remote site compresses the computer file of the recorded noise and, the expert site un-compresses the computer file of the recorded noise.
